(19) United States
(12) Patent Application Publication
(10) Pub. No.: US 2023/0178067 A1
(43) Pub. Date: Jun. 8, 2023

(54) METHOD OF TRAINING SPEECH SYNTHESIS MODEL AND METHOD OF SYNTHESIZING SPEECH

(71) Applicant: BEIJING BAIDU NETCOM SCIENCE TECHNOLOGY CO., LTD., Beijing (CN)

(72) Inventors: Wenfu WANG, Beijing (CN); Tao SUN, Beijing (CN); Xilei WANG, Beijing (CN); Lei JIA, Beijing (CN)

(73) Assignee: BEIJING BAIDU NETCOM SCIENCE TECHNOLOGY CO., LTD., Beijing (CN)

(21) Appl. No.: 18/074,023

(22) Filed: Dec. 2, 2022

(30) Foreign Application Priority Data
Dec. 7, 2021 (CN) 202111494736.5

(51) Int. Cl. G10L 13/047; G10L 25/30

(52) U.S. Cl. CPC G10L 13/047; G10L 25/30

(57) ABSTRACT

A method of training a speech synthesis method, a method of synthesizing a speech, a device and a storage medium are provided, which relate to a field of artificial intelligence technology, in particular to a field of speech synthesis technology. The specific implementation scheme includes: processing training data by using the speech synthesis model, so as to determine a content encoding sequence, a style encoding sequence, a timbre encoding vector, a noise environment vector and a target Mel spectrum sequence corresponding to the training data; determine a total loss value according to the content encoding sequence, the style encoding sequence, the timbre encoding vector, the noise environment vector and the target Mel spectrum sequence; and adjusting a parameter of the speech synthesis model according to the total loss value.

This application claims priority to Chinese Patent Application No. 202111494736.5 filed on Dec. 7, 2021, which is incorporated herein in its entirety by reference.

### TECHNICAL FIELD

The present disclosure relates to a field of artificial intelligence, in particular to a field of speech synthesis technology.

### BACKGROUND

The current speech synthesis technology (Text-to-Speech, TTS) has been greatly improved in terms of both sound quality and natural fluency. However, the current technology is modeling based on high-quality voice data, and the data tend to be costly. Nowadays, with the continuous enrichment of application scenarios of speech synthesis technology, the speech synthesis technology is increasingly applied to user data scenarios. However, the quality of voice data that may be obtained in many user data scenarios is low, which poses a new challenge to the acoustic modeling technology.

### SUMMARY

The present disclosure provides a method of training a speech synthesis model, a method of synthesizing a speech, a device and a storage medium.

According to one aspect of the present disclosure, there is provided a method of training a speech synthesis model, including: processing training data by using the speech synthesis model, so as to determine a content encoding sequence, a style encoding sequence, a timbre encoding vector, a noise environment vector, and a target Mel spectrum sequence corresponding to the training data; determining a total loss value according to the content encoding sequence, the style encoding sequence, the timbre encoding vector, the noise environment vector and the target Mel spectrum sequence; and adjusting a parameter of the speech synthesis model according to the total loss value.

According to another aspect of the present disclosure, there is provided a method of synthesizing a speech, including: determining a target spectrum sequence according to a target text, a target style, a target timbre, and a target noise environment by using a speech synthesis model; and generating a target audio according to the target spectrum sequence, wherein the speech synthesis model is trained according to the method described in the embodiments of the present disclosure.

Another aspect of the present disclosure provides an electronic device, including: at least one processor; and a memory communicatively coupled with the at least one processor; the memory stores instructions executable by the at least one processor, and the instructions, when executed by the at least one processor, cause the at least one processor to implement the method shown in the embodiments of the present disclosure.

According to another aspect of the embodiments of the present disclosure, there is provided a non-transitory computer readable storage medium storing computer instructions, the computer instructions are configured to cause a computer to implement the method shown in the embodiments of the present disclosure.

It should be understood that the content described in this part is not intended to identify the key or important features of the embodiments of this disclosure, nor is it used to limit the scope of this disclosure. Other features of the present disclosure will be readily understood by the following description.

### BRIEF DESCRIPTION OF THE DRAWINGS

The accompanying drawings are used for better understanding of the solution and do not constitute a limitation to the present disclosure, in which:

FIG. 1 schematically shows a flowchart of a method of training a speech synthesis model according to an embodiment of the present disclosure;

FIG. 2 schematically shows a schematic diagram of a speech synthesis model according to an embodiment of the present disclosure;

FIG. 3 schematically shows a flowchart of a method of determining a content encoding sequence, a style encoding sequence, a timbre encoding vector, a noise environment vector, and a target Mel spectrum sequence corresponding to the training data according to an embodiment of the present disclosure;

FIG. 4 schematically shows a flowchart of a method of determining a total loss value according to an embodiment of the present disclosure;

FIG. 5 schematically shows a schematic diagram of training a speech synthesis model according to another embodiment of the present disclosure;

FIG. 6 schematically shows a flowchart of a method of synthesizing a speech according to an embodiment of the present disclosure;

FIG. 7 schematically shows a flowchart of a method of generating a target spectrum sequence according to an embodiment of the present disclosure;

FIG. 8 schematically shows a block diagram of an apparatus of training a speech synthesis model according to an embodiment of the present disclosure;

FIG. 9 schematically shows a block diagram of an apparatus of synthesizing a speech according to an embodiment of the present disclosure; and

FIG. 10 schematically shows a block diagram of an example electronic device that may be used to implement embodiments of the present disclosure.

### DETAILED DESCRIPTION OF EMBODIMENTS

Exemplary embodiments of the present disclosure will be described below with reference to the accompanying drawings, which include various details of the embodiments of the present disclosure to facilitate understanding and should be considered as merely exemplary. Therefore, those of ordinary skilled in the art should realize that various changes and modifications may be made to the embodiments described herein without departing from the scope and spirit of the present disclosure. Likewise, for clarity and conciseness, descriptions of well-known functions and structures are omitted in the following description.

Collecting, storing, using, processing, transmitting, providing, disclosing, and applying etc. of the personal information of the user involved in the present disclosure all comply with the relevant laws and regulations, take essential confidentiality measures, and do not violate the public order and morals. In the technical solution of the present disclosure, authorization or consent is obtained from the user before the user’s personal information is obtained or collected.

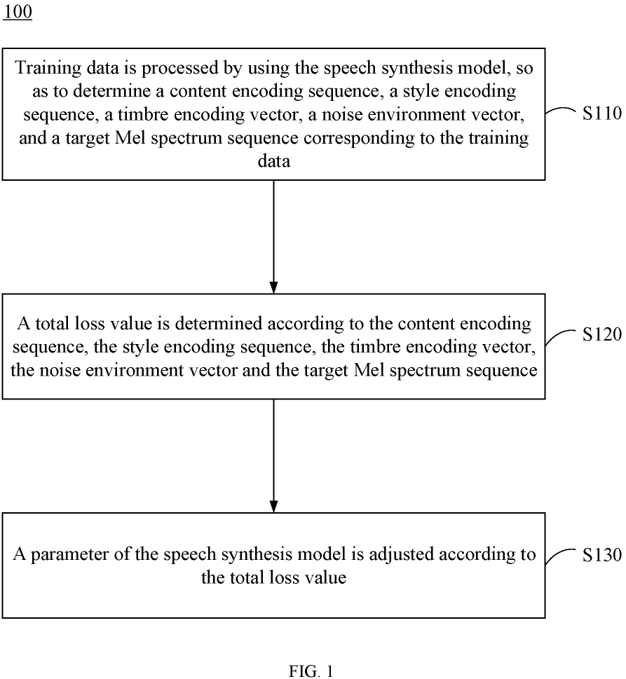

The method of training a speech synthesis model provided by the present disclosure will be described below with reference to FIG. 1.

FIG. 1 schematically shows a flowchart of a method of training a speech synthesis model according to an embodiment of the present disclosure.

As shown in FIG. 1, the method 100 of training a speech synthesis model includes operations S110 to S130. In operation S110, training data is processed by using the speech synthesis model, so as to determine a content encoding sequence, a style encoding sequence, a timbre encoding vector, a noise environment vector, and a target Mel spectrum sequence corresponding to the training data.

Then, in operation S120, a total loss value is determined according to the content encoding sequence, the style encoding sequence, the timbre encoding vector, the noise environment vector and the target Mel spectrum sequence.

In operation S130, a parameter of the speech synthesis model is adjusted according to the total loss value.

In related technologies, modeling based on high-quality audio data is required, but modeling based on low-quality data is not supported. However, obtaining high-quality audio data tends to be costly.

According to the embodiments of the present disclosure, the trained speech synthesis model has a low requirement of inputting data, thus reducing the dependence of speech synthesis on high-quality data. In addition, the timbre, the style and the noise environment are decoupled in the speech synthesis model, so as to train a cross-style, cross-timbre and noise-reduction-supported speech synthesis model.

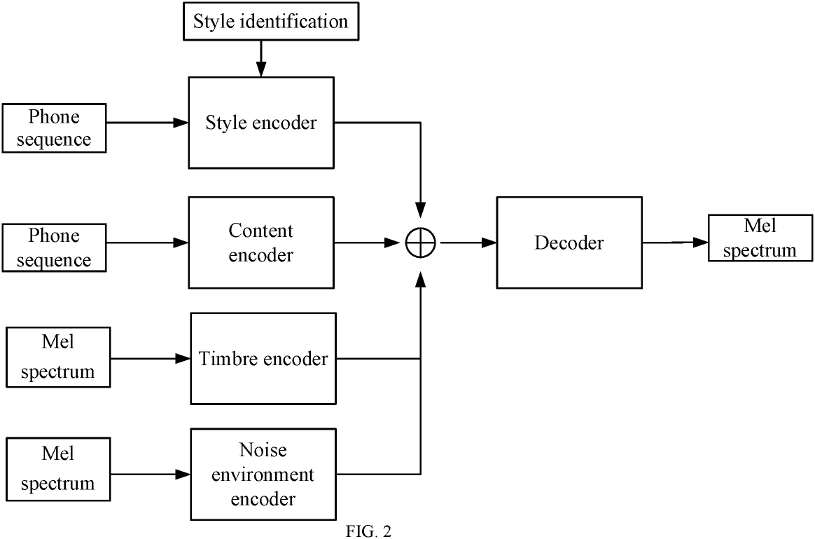

The speech synthesis model according to the embodiments of the present disclosure will be described below with reference to FIG. 2.

FIG. 2 schematically shows a schematic diagram of a speech synthesis model according to an embodiment of the present disclosure.

As shown in FIG. 2, the speech synthesis models may include a content encoder, a style encoder, a timbre encoder, a noise environment encoder and a decoder.

According to the embodiments of the present disclosure, a phone sequence of a text may be input into the content encoder. The phone sequence may contain a plurality of phones. The phone is the smallest phonetic unit obtained by segmenting a speech from a perspective of sound quality, which is a representation of text pronunciation. The content encoder may be used to encode an input phone sequence and generate a corresponding content encoding sequence. Each phone of the phone sequence corresponds to an encoding vector of the content encoding sequence. The content encoder may be used to determine how each phone is pronounced.

According to the embodiments of the present disclosure, the content encoder may include, for example, a plurality of convolutional layers and a bidirectional long short-term memory (LSTM) artificial neural network, the plurality of convolutional layers are connected in a manner of residual connection. The bidirectional long short-term memory artificial neural network increases a reverse information of the sequence, so that the prediction effect of the content encoder is better.

According to the embodiments of the present disclosure, the phone sequence of the text and a style ID may be input into the style encoder. Exemplarily, in this embodiment, a variety of styles may be set in advance, and a style identification may be set for each style. The style encoder may be used to encode the input phone sequence, and may also control the encoding style according to the input style identification to generate a corresponding style encoding sequence. Each phone of the phone sequence corresponds to an encoding vector of the style encoding sequence. The style encoder may be used to determine a pronunciation mode of each phone, that is the style.

According to the embodiments of the present disclosure, the style encoder may include, for example, a plurality of convolutional layers and a recurrent neural network (RNN). RNN may have an autoregressive characteristic, which is helpful to improve the prediction effect.

According to the embodiments of the present disclosure, the timbre encoder may be used to encode a Mel spectrum sequence of a sentence and extract the timbre vector of the sentence. The timbre encoder may be used to determine the timbre to be synthesized for a speech, such as timbre A, B, C, etc.

According to the embodiments of the present disclosure, the timbre encoder may include, for example, a plurality of convolutional layers and a gated recurrent unit (GRU).

According to the embodiments of the present disclosure, the noise environment encoder may be used to encode the Mel spectrum sequence of a sentence and extract the noise environment vector of the sentence. The noise environment vector may, for example, represent features such as background noise, reverberation, or clean (i.e., no noise or reverberation) contained in a sentence. According to the embodiments of the present disclosure, when performing a speech synthesis, high-definition speech synthesis may be achieved by giving the Mel spectrum sequence of a clean sentence.

According to an embodiment of the present disclosure, the noise environment encoder may include, for example, a plurality of convolutional layers and a gated recurrent unit.

According to the embodiments of the present disclosure, the decoder may generate the Mel spectrum sequence of the target speech by using the output of the content encoder, the output of the style encoder, the output of the timbre encoder and the output of the noise environment encoder as an input of the decoder. The decoder may be used to generate a corresponding speech feature sequence according to the combination of the input content, the input style, the input timbre and the input noise environment information.

According to an embodiment of the present disclosure, the decoder may include, for example, an autoregressive structure based on an attention mechanism.

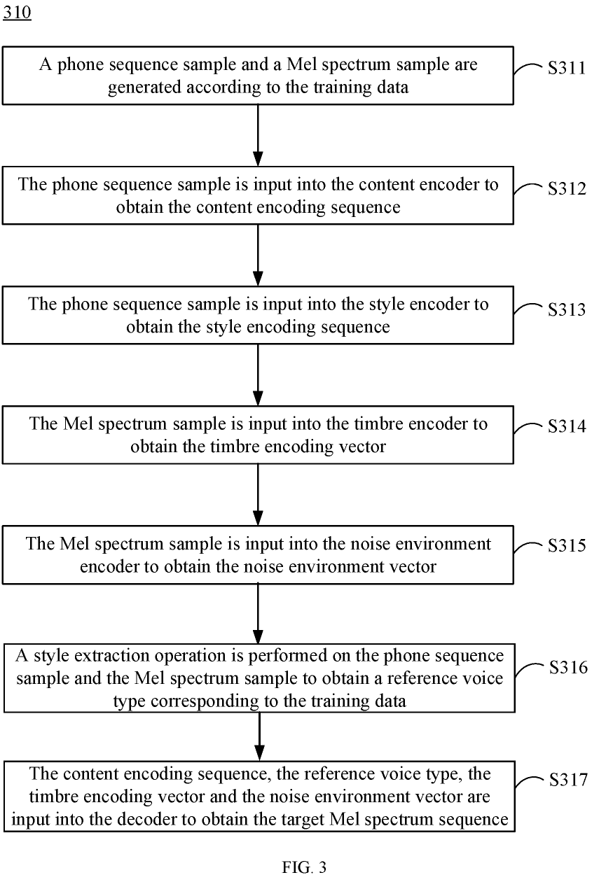

The method of determining a content encoding sequence, a style encoding sequence, a timbre encoding vector, a noise environment vector and a target Mel spectrum sequence corresponding to training data according to the embodiments of the present disclosure will be described below with reference to FIG. 3.

FIG. 3 schematically shows a flowchart of a method of determining a content encoding sequence, a style encoding sequence, a timbre encoding vector, a noise environment vector, and a target Mel spectrum sequence corresponding to the training data according to an embodiment of the present disclosure.

As shown in FIG. 3, the method 310 of determining the content encoding sequence, the style encoding sequence, the timbre encoding vector, the noise environment vector and the target Mel spectrum sequence corresponding to the training data may include operations S311 to S317. In operation S311, a phone sequence sample and a Mel spectrum sample are generated according to the training data.

According to the embodiments of the present disclosure, the training data includes clean data (that is, no noise or reverberation) and data with noise. Exemplarily, audio data containing speech may be collected in advance, and then background noise and reverberation may be randomly added to these audio data according to a certain probability to obtain the training data.

According to the embodiments of the present disclosure, text data may be determined according to the training data. Then the text data may be converted into a tonal phone sequence as a phone sequence sample. Exemplarily, in this embodiment, for example, a text pre-processing module may be used to convert the text data into the phone sequence. In addition, any sentence may be selected from the training data, and the Mel spectrum sequence of the sentence may be determined as a Mel spectrum sequence sample.

In operation S312, the phone sequence sample is input into the content encoder to obtain the content encoding sequence.

According to the embodiments of the present disclosure, for example, the content encoder may be used to encode the phone sequence sample to generate a corresponding content encoding sequence.

In operation S313, the phone sequence sample is input into the style encoder to obtain the style encoding sequence.

According to the embodiments of the present disclosure, for example, the phone sequence sample and the style identification corresponding to the phone sequence sample may be input into the style encoder, and the style encoder may be used to encode the phone sequence sample to generate a corresponding style encoding sequence.

In operation S314, the Mel spectrum sample is input into the timbre encoder to obtain the timbre encoding vector.

According to the embodiments of the present disclosure, for example, the timbre encoder may be used to encode the Mel spectrum sample and extract the timbre vector of the Mel spectrum sample.

In operation S315, the Mel spectrum sample is input into a noise environment encoder to obtain the noise environment vector.

According to the embodiments of the present disclosure, for example, the noise environment encoder may be used to encode the Mel spectrum sample and extract the noise environment vector of the Mel spectrum sample.

In operation S316, a style extraction operation is performed on the phone sequence sample and the Mel spectrum sample to obtain a reference voice type corresponding to the training data.

According to the embodiments of the present disclosure, for example, a style extractor may be used to extract the style of the phone sequence sample and the style of the Mel spectrum sample to obtain the reference voice type corresponding to the training data.

Exemplarily, in this embodiment, the style extractor may be used to determine a reference Mel encoding sequence according to the Mel spectrum sample, and determine a reference phone encoding sequence according to the phone sequence sample, and then determine the reference voice type according to the reference Mel encoding sequence and the reference phone encoding sequence by using the attention mechanism.

According to the embodiments of the present disclosure, the reference voice type corresponding to the training data may be determined by performing the style extraction operation on the phone sequence sample and the Mel spectrum sample, and the reference voice type may be used to assist the learning of the style encoder.

In operation S317, the content encoding sequence, the reference voice type, the timbre encoding vector and the noise environment vector are input into the decoder to obtain the target Mel spectrum sequence.

According to the implementation of the present disclosure, operations S312 to S316 may be performed simultaneously or sequentially in any order, which is not specifically limited in the present disclosure.

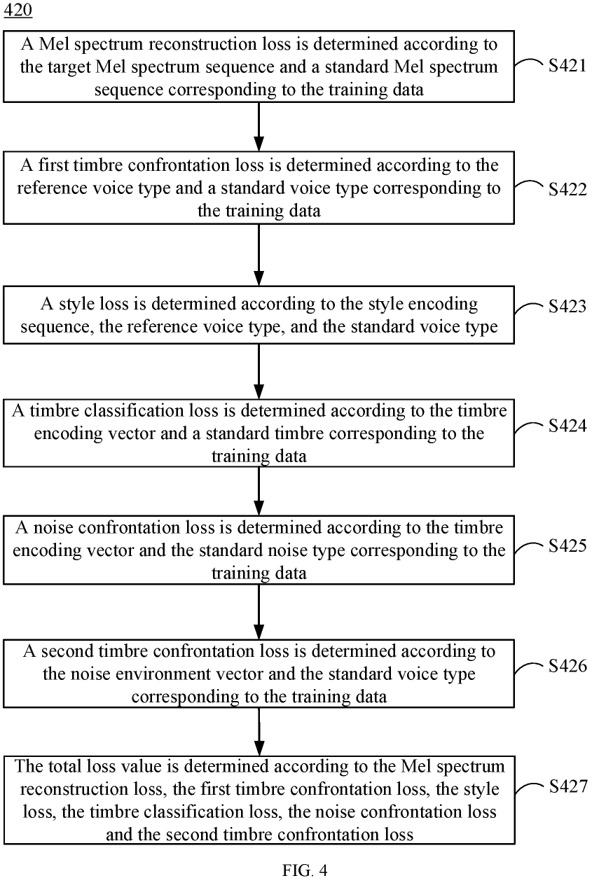

A method of determining a total loss value according to the embodiments of the present disclosure will be described below with reference to FIG. 4.

FIG. 4 schematically shows a flowchart of a method of determining a total loss value according to an embodiment of the present disclosure.

As shown in FIG. 4, the method 420 of determining the total loss value may include operations S421 to S427. In operation S421, a Mel spectrum reconstruction loss is determined according to the target Mel spectrum sequence and a standard Mel spectrum sequence corresponding to the training data.

According to the embodiments of the present disclosure, the standard Mel spectrum sequence corresponding to the training data may be set in advance.

According to the embodiments of the present disclosure, the Mel spectrum reconstruction loss may be used to ensure the overall model convergence.

According to the embodiments of the present disclosure, for example, a mean square error (MSE) between the target Mel spectrum sequence and the standard Mel spectrum sequence corresponding to the training data may be calculated as the Mel spectrum reconstruction loss.

In operation S422, a first timbre confrontation loss is determined according to the reference voice type and a standard voice type corresponding to the training data.

According to the embodiments of the present disclosure, the first timbre confrontation loss may be used to eliminate the timbre from the style and realize the decoupling of style and timbre.

According to the embodiments of the present disclosure, the standard voice type corresponding to the training data may be set in advance.

According to the embodiments of the present disclosure, for example, a cross entropy between the reference voice type and the standard voice type may be calculated as the first timbre confrontation loss.

In operation S423, a style loss is determined according to the style encoding sequence, the reference voice type, and the standard voice type.

According to the embodiments of the present disclosure, the style loss may be used for the learning of the style encoder.

According to the embodiments of the present disclosure, for example, the mean square error between the style encoding sequence, the reference voice type and the standard voice type may be calculated as the style loss.

In operation S424, a timbre classification loss is determined according to the timbre encoding vector and a standard timbre corresponding to the training data.

According to the embodiments of the present disclosure, the standard timbre corresponding to the training data may be set in advance.

According to the embodiments of the present disclosure, the timbre classification loss may be used to assist timbre clustering.

According to the embodiments of the present disclosure, for example, a cross entropy between the timbre encoding vector and the standard timbre may be calculated as the timbre classification loss.

In operation S425, a noise confrontation loss is determined according to the timbre encoding vector and the standard noise type corresponding to the training data.

According to the embodiments of the present disclosure, the noise confrontation loss may be used to eliminate the noise environment from the timbre.

According to the embodiments of the present disclosure, for example, a cross entropy between the timbre encoding vector and the standard noise type may be calculated as the voice classification loss.

In operation S426, a second timbre confrontation loss is determined according to the noise environment vector and the standard voice type corresponding to the training data.

According to the embodiments of the present disclosure, the second timbre confrontation loss may be used to eliminate the timbre from the noise environment.

According to the embodiments of the present disclosure, for example, a cross entropy between the noise environment vector and the standard voice type may be calculated as the second timbre confrontation loss.

In operation S427, the total loss value is determined according to the Mel spectrum reconstruction loss, the first timbre confrontation loss, the style loss, the timbre classification loss, the noise confrontation loss and the second timbre confrontation loss.

According to the embodiments of the present disclosure, for example, a weighted sum operation may be performed on the Mel spectrum reconstruction loss, the first timbre confrontation loss, the style loss, the timbre classification loss, the noise confrontation loss and the second timbre confrontation loss to obtain the total loss value. The weight of the Mel spectrum reconstruction loss, the weight of the first timbre confrontation loss, the weight of the style loss, the weight of the timbre classification loss, the weight of the noise confrontation loss and the weight of the second timbre confrontation loss may be set according to actual needs, which is not specifically limited in the present disclosure.

According to the embodiments of the present disclosure, in the process of training, the noise confrontation loss and the second timbre confrontation loss may decouple the timbre and the noise environment. The Mel spectrum reconstruction loss, the timbre classification loss, the noise confrontation loss and the second timbre confrontation loss may decouple the style, the timbre and the noise environment. Thus, after training, a cross-style, cross-timbre and noise-reduction-supported speech synthesis model may be trained.

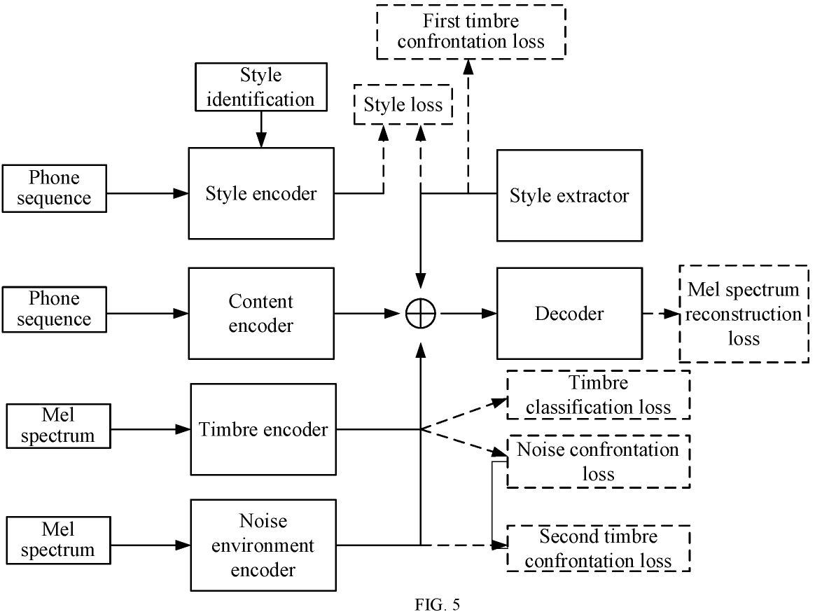

The method of training a speech synthesis model shown above is further described below with reference to FIG. 5.

FIG. 5 schematically shows a schematic diagram of a method of training a speech synthesis model according to another embodiment of the present disclosure.

As shown in FIG. 5, a phone sequence sample of a text is input into a content encoder to obtain a content encoding sequence. The phone sequence sample of the text is input into a style encoder to obtain a style encoding sequence. A Mel spectrum sample is input into a timbre encoder to obtain a timbre encoding vector. The Mel spectrum sample is input into a noise environment encoder to obtain a noise environment vector. A style extractor is used to extract the style from the training data, to obtain a reference voice type corresponding to the training data. Then, the content encoding sequence, the reference voice type, the timbre encoding vector and the noise environment vector are input into the decoder to obtain a target Mel spectrum sequence.

Next, a Mel spectrum reconstruction loss is determined according to the target Mel spectrum sequence and the standard Mel spectrum sequence corresponding to the training data. A first timbre confrontation loss is determined according to the reference voice type and the standard voice type corresponding to the training data. A style loss is determined according to the style encoding sequence, the reference voice type and the standard voice type. A timbre classification loss is determined according to the timbre encoding vector and the standard timbre corresponding to the training data. A noise confrontation loss is determined according to the timbre encoding vector and the standard noise type corresponding to the training data. A second timbre confrontation loss is determined according to the noise environment vector and the standard voice type corresponding to the training data. Then, a total loss value is determined by a weighted sum of the Mel spectrum reconstruction loss, the first timbre confrontation loss, the style loss, the timbre classification loss, the noise confrontation loss and the second timbre confrontation loss.

Then, the parameter of the speech synthesis model is adjusted according to the total loss value, and the above training process is repeated until the total loss value converges.

According to the embodiments of the present disclosure, the trained speech synthesis model has the low requirement of inputting data, thus reducing the dependence of speech synthesis on high-quality data. In addition, the timbre, the style and the noise environment in the speech synthesis model are decoupled, so as to train a cross-style, cross-timbre, and noise-reduction-supported speech synthesis model.

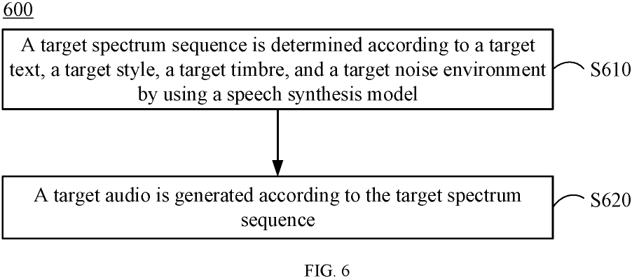

The method of synthesizing a speech provided in the present disclosure will be described below with reference to FIG. 6.

FIG. 6 schematically shows a flowchart of a method of synthesizing a speech according to an embodiment of the present disclosure.

As shown in FIG. 6, the method 600 of synthesizing a speech includes operations S610 to S620. In operation S610, a target spectrum sequence is determined according to a target text, a target style, a target timbre, and a target noise environment by using a speech synthesis model.

In operation S620, a target audio is generated according to the target spectrum sequence.

According to the embodiments of the present disclosure, the target spectrum sequence may be a Mel spectrum sequence of the target audio, and the target audio is a result of synthesizing the speech. The target text may be used to set phones contained in the target audio. The target style may be used to set a pronunciation mode of the target audio. The target timbre may be used to set a timbre of the target audio. The target noise environment may be used to set a noise, reverberation, or noise reduction for the target audio.

According to the implementation of the present disclosure, the speech synthesis model may include, for example, a content encoder, a style encoder, a timbre encoder, a noise environment encoder, and a decoder. The speech synthesis model may, for example, be trained according to the method of training the speech synthesis model shown in the embodiments of the present disclosure.

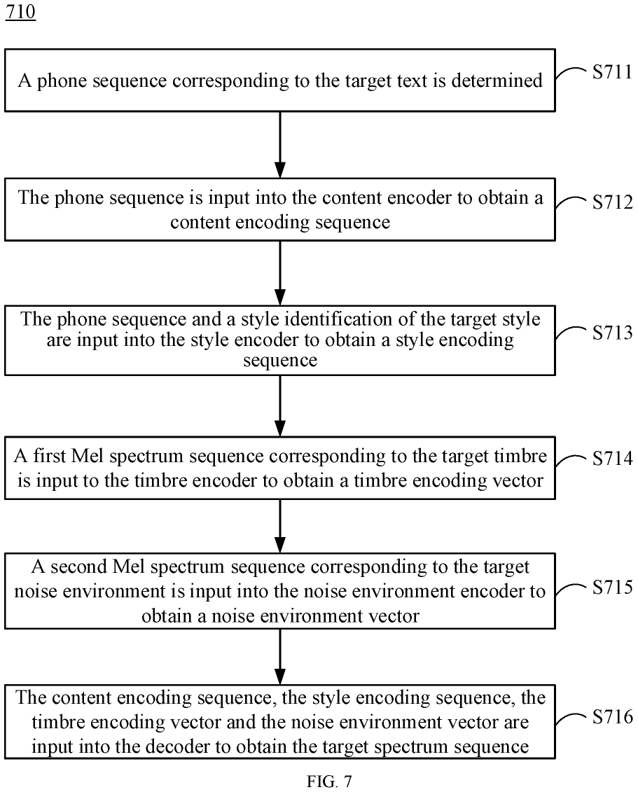

FIG. 7 schematically shows a flowchart of a method for generating a target spectrum sequence according to an embodiment of the present disclosure.

As shown in FIG. 7, the method 710 of generating the target spectrum sequence includes operations S711 to S716. In operation S711, a phone sequence corresponding to the target text is determined.

According to the embodiments of the present disclosure, for example, a text preprocessing module may be used to convert the target text into a phone sequence.

In operation S712, the phone sequence is input into the content encoder to obtain a content encoding sequence.

According to the embodiments of the present disclosure, for example, a content encoder may be used to encode the phone sequence to generate a corresponding content encoding sequence.

In the operation of S713, the phone sequence and a style identification of the target style are input into the style encoder to obtain a style encoding sequence.

According to the embodiments of the present disclosure, for example, a style encoder may be used to encode the phone sequence according to the style identification to generate a corresponding style encoding sequence.

In operation S714, a first Mel spectrum sequence corresponding to the target timbre is input to the timbre encoder to obtain a timbre encoding vector.

According to the embodiments of the present disclosure, the corresponding Mel spectrum sequences may be set for different timbres in advance. The Mel spectrum sequence is a Mel spectrum sequence corresponding to a speech with the timbre. It may be understood that the first Mel spectrum sequence is the Mel spectrum sequence corresponding to the target timbre.

According to the embodiments of the present disclosure, for example, the timbre encoder may be used to encode the first Mel spectrum sequence corresponding to the target timbre to determine a timbre vector corresponding to the target timbre.

In operation S715, a second Mel spectrum sequence corresponding to the target noise environment is input into the noise environment encoder to obtain a noise environment vector.

According to the embodiments of the present disclosure, the corresponding Mel spectrum sequences may be set for different noise environments in advance. The Mel spectrum sequence is the Mel spectrum sequence corresponding to a speech with the noise environment. It may be understood that the second Mel spectrum sequence is the Mel spectrum sequence corresponding to the target noise environment.

According to the embodiments of the present disclosure, for example, the second Mel spectrum may be encoded by using the noise environment encoder to extract the noise environment vector to be synthesized.

In operation S716, the content encoding sequence, the style encoding sequence, the timbre encoding vector and the noise environment vector are input into the decoder to obtain the target spectrum sequence.

According to the embodiments of the present disclosure, the decoder may generate a Mel spectrum sequence with target style, target voice, and target environment noise, that is, the target spectrum sequence, according to the input content encoding sequence, the input style encoding sequence, the input timbre encoding vector, and the input noise environment vector.

According to the embodiments of the present disclosure, the timbre encoder, the style encoder and the noise environment encoder are decoupled from each other, realizing cross-style, cross-voice and supporting noise reduction in synthesizing the speech, and the effect of synthesizing the speech is improved.

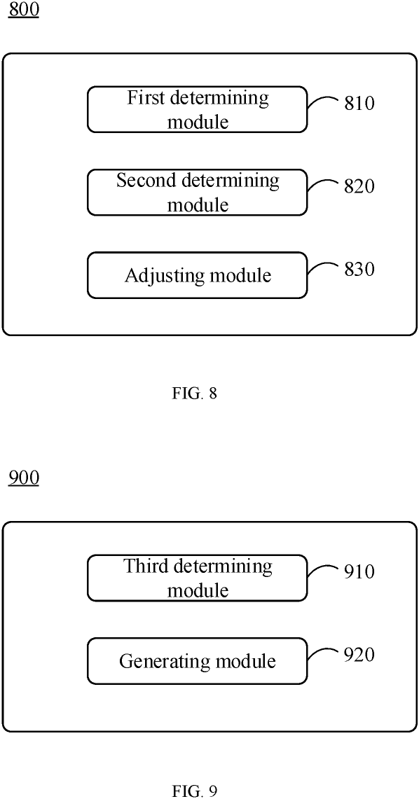

FIG. 8 schematically shows a block diagram of an apparatus of training a speech synthesis model according to an embodiment of the present disclosure.

As shown in FIG. 8, the apparatus 800 of training the speech synthesis model includes a first determining module 810, a second determining module 820, and an adjusting module 830.

The first determining module 810 is used to process training data by using the speech synthesis model, so as to determine a content encoding sequence, a style encoding sequence, a timbre encoding vector, a noise environment vector and a target Mel spectrum sequence corresponding to the training data;

The second determining module 820 is used to determine a total loss value according to the content encoding sequence, the style encoding sequence, the timbre encoding vector, the noise environment vector and the target Mel spectrum sequence; and

The adjusting module 830 is used to adjust a parameter of the speech synthesis model according to the total loss value.

FIG. 9 schematically shows a block diagram of an apparatus of synthesizing a speech according to an embodiment of the present disclosure.

As shown in FIG. 9, the apparatus 900 of synthesizing a speech includes a third determining module 910 and a generating module 920.

The third determining module 910 is used to determine a target spectrum sequence according to a target text, a target style, a target timbre and a target noise environment by using a speech synthesis model.

The generating module 920 is used to generate a target audio according to the target spectrum sequence.

The speech synthesis model may be trained according to the method of training the speech synthesis model in the embodiments of the present disclosure.

According to the embodiments of the present disclosure, the present disclosure further provides an electronic device, a readable storage medium, and a computer program product.

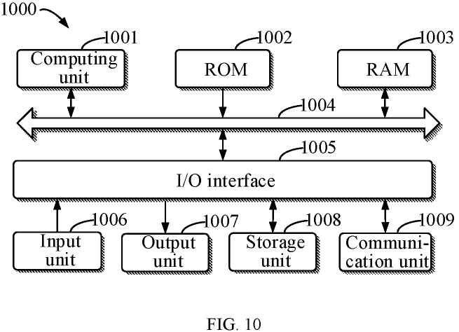

FIG. 10 shows a schematic block diagram of an example electronic device 1000 that may be used to implement the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 10, the electronic device 1000 may include computing unit 1001, which may perform various appropriate actions and processing based on a computer program stored in a read-only memory (ROM) 1002 or a computer program loaded from a storage unit 1008 into a random access memory (RAM) 1003. Various programs and data required for the operation of the electronic device 1000 may be stored in the RAM 1003. The computing unit 1001, the ROM 1002 and the RAM 1003 are connected to each other through a bus 1004. An input/output (I/O) interface 1005 is further connected to the bus 1004.

Various components in the electronic device 1000 are connected with I/O interface 1005, including an input unit 1006, such as a keyboard, a mouse, etc.; an output unit 1007, such as various types of displays, speakers, etc.; a storage unit 1008, such as a magnetic disk, an optical disk, etc.; and a communication unit 1009, such as a network card, a modem, a wireless communication transceiver, etc. The communication unit 1009 allows the electronic device 1000 to exchange information/data with other devices through a computer network such as the Internet and/or various telecommunication networks.

The computing unit 1001 may be various general-purpose and/or special-purpose processing components with processing and computing capabilities. Some examples of the computing unit 1001 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 1001 may perform the various methods and processes described above, such as the method of training a speech synthesis model and the method of synthesizing a speech. For example, in some embodiments, the method of training a speech synthesis model and the method of synthesizing a speech may be implemented as a computer software program that is tangibly contained on a machine-readable medium, such as a storage unit 1008. In some embodiments, part or all of a computer program may be loaded and/or installed on the electronic device 1000 via the ROM 1002 and/or the communication unit 1009. When the computer program is loaded into the RAM 1003 and executed by the computing unit 1001, one or more steps of the method of training a speech synthesis model and the method of synthesizing a speech described above may be performed. Alternatively, in other embodiments, the computing unit 1001 may be configured to perform the method of training a speech synthesis model and the method of synthesizing a speech in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

A computer system may include a client and a server. The client and the server are generally far away from each other and usually interact through a communication network. The relationship between the client and the server is generated through computer programs running on the corresponding computers and having a client-server relationship with each other.

The server may be a cloud server, also referred to as a cloud computing server or a cloud host, which is a host product in the cloud computing service system to overcome the defect of the traditional physical host and VPS service (“virtual private server”, or “VPS”). The defect of the traditional physical host and VPS service is difficult to manage and the business scalability is weak. The server may also be a server of a distributed system or a server combined with a blockchain

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of training a speech synthesis model, the method comprising:
processing training data by using the speech synthesis model, so as to determine a content encoding sequence, a style encoding sequence, a timbre encoding vector, a noise environment vector, and a target Mel spectrum sequence corresponding to the training data;
determining a total loss value according to the content encoding sequence, the style encoding sequence, the timbre encoding vector, the noise environment vector and the target Mel spectrum sequence; and
adjusting a parameter of the speech synthesis model according to the total loss value.

2. The method of claim 1, wherein the speech synthesis model comprises a content encoder, a style encoder, a timbre encoder, a noise environment encoder, and a decoder; and
wherein determining the content encoding sequence, the style encoding sequence, the timbre encoding vector, the noise environment vector, and the target Mel spectrum sequence corresponding to the training data comprises:
generating a phone sequence sample and a Mel spectrum sample according to the training data;
inputting the phone sequence sample into the content encoder to obtain the content encoding sequence;
inputting the phone sequence sample into the style encoder to obtain the style encoding sequence;
inputting the Mel spectrum sample into the timbre encoder to obtain the timbre encoding vector;
inputting the Mel spectrum sample into the noise environment encoder to obtain the noise environment vector;
performing style extraction on the phone sequence sample and the Mel spectrum sample to obtain a reference voice type corresponding to the training data; and
inputting the content encoding sequence, the reference voice type, the timbre encoding vector and the noise environment vector into the decoder to obtain the target Mel spectrum sequence.

3. The method of claim 2, wherein the determining a total loss value according to the content encoding sequence, the style encoding sequence, the timbre encoding vector, the noise environment vector and the target Mel spectrum sequence comprises:
determining a Mel spectrum reconstruction loss according to the target Mel spectrum sequence and a standard Mel spectrum sequence corresponding to the training data;
determining a first timbre confrontation loss according to the reference voice type and a standard voice type corresponding to the training data;
determining a style loss according to the style encoding sequence, the reference voice type and the standard voice type;
determining a timbre classification loss according to the timbre encoding vector and a standard timbre corresponding to the training data;
determining a noise confrontation loss according to the timbre encoding vector and a standard noise type corresponding to the training data;
determining a second timbre confrontation loss according to the noise environment vector and the standard voice type corresponding to the training data; and
determining the total loss value according to the Mel spectrum reconstruction loss, the first timbre confrontation loss, the style loss, the timbre classification loss, the noise confrontation loss and the second timbre confrontation loss.

4. The method of claim 2, wherein the content encoder comprises a plurality of convolutional layers and a bidirectional long short-term memory artificial neural network, wherein the plurality of convolutional layers are connected to each other in a manner of residual connection.

5. The method of claim 2, wherein the style encoder comprises a plurality of convolutional layers and a recurrent neural network.

6. The method of claim 2, wherein the timbre encoder comprises a plurality of convolutional layers and a gated recurrent unit.

7. The method of claim 2, wherein the noise environment encoder comprises a plurality of convolutional layers and a gated recurrent unit.

8. The method of claim 2, wherein the decoder comprises an autoregressive structure based on an attention mechanism.

9. A method of synthesizing a speech, the method comprising:
determining a target spectrum sequence according to a target text, a target style, a target timbre and a target noise environment by using a speech synthesis model; and generating a target audio according to the target spectrum sequence,
wherein the speech synthesis model is trained according to the method of claim 1.

10. The method of claim 9, wherein the speech synthesis model comprises a content encoder, a style encoder, a timbre encoder, a noise environment encoder, and a decoder; and
wherein the determining a target spectrum sequence according to a target text, a target style, a target timbre and a target noise environment by using the speech synthesis model comprises:
determining a phone sequence corresponding to the target text;
inputting the phone sequence into the content encoder to obtain a content encoding sequence;
inputting the phone sequence and a style identification of the target style into the style encoder to obtain a style encoding sequence;
inputting a first Mel spectrum sequence corresponding to the target timbre into the timbre encoder to obtain a timbre encoding vector;
inputting a second Mel spectrum sequence corresponding to the target noise environment into the noise environment encoder to obtain a noise environment vector; and
inputting the content encoding sequence, the style encoding sequence, the timbre encoding vector and the noise environment vector into the decoder to obtain the target spectrum sequence.

11. An electronic device, comprising:
at least one processor; and
a memory communicatively coupled with the at least one processor, wherein the memory stores instructions executable by the at least one processor, the instructions, when executed by the at least one processor, configured to cause the at least one processor to at least:
process training data by using the speech synthesis model, so as to determine a content encoding sequence, a style encoding sequence, a timbre encoding vector, a noise environment vector, and a target Mel spectrum sequence corresponding to the training data;
determine a total loss value according to the content encoding sequence, the style encoding sequence, the timbre encoding vector, the noise environment vector and the target Mel spectrum sequence; and
adjust a parameter of the speech synthesis model according to the total loss value.

12. The electronic device of claim 11, wherein the speech synthesis model comprises a content encoder, a style encoder, a timbre encoder, a noise environment encoder, and a decoder; and
wherein the instructions are further configured to cause the at least one processor to:
generate a phone sequence sample and a Mel spectrum sample according to the training data;
input the phone sequence sample into the content encoder to obtain the content encoding sequence;
input the phone sequence sample into the style encoder to obtain the style encoding sequence;
input the Mel spectrum sample into the timbre encoder to obtain the timbre encoding vector;
input the Mel spectrum sample into the noise environment encoder to obtain the noise environment vector;
perform style extraction on the phone sequence sample and the Mel spectrum sample to obtain a reference voice type corresponding to the training data; and
input the content encoding sequence, the reference voice type, the timbre encoding vector and the noise environment vector into the decoder to obtain the target Mel spectrum sequence.

13. The electronic device of claim 12, wherein the instructions are further configured to cause the at least one processor to:
determine a Mel spectrum reconstruction loss according to the target Mel spectrum sequence and a standard Mel spectrum sequence corresponding to the training data;
determine a first timbre confrontation loss according to the reference voice type and a standard voice type corresponding to the training data;
determine a style loss according to the style encoding sequence, the reference voice type and the standard voice type;
determine a timbre classification loss according to the timbre encoding vector and a standard timbre corresponding to the training data;
determine a noise confrontation loss according to the timbre encoding vector and a standard noise type corresponding to the training data;
determine a second timbre confrontation loss according to the noise environment vector and the standard voice type corresponding to the training data; and
determine the total loss value according to the Mel spectrum reconstruction loss, the first timbre confrontation loss, the style loss, the timbre classification loss, the noise confrontation loss and the second timbre confrontation loss.

14. The electronic device of claim 12, wherein the content encoder comprises a plurality of convolutional layers and a bidirectional long short-term memory artificial neural network, and wherein the plurality of convolutional layers are connected to each other in a manner of residual connection.

15. The electronic device of claim 12, wherein the style encoder comprises a plurality of convolutional layers and a recurrent neural network.

16. The electronic device of claim 12, wherein the timbre encoder comprises a plurality of convolutional layers and a gated recurrent unit.

17. The electronic device of claim 12, wherein the noise environment encoder comprises a plurality of convolutional layers and a gated recurrent unit.

18. An electronic device, comprising:
at least one processor; and
a memory communicatively coupled with the at least one processor, wherein the memory stores instructions executable by the at least one processor, the instructions, when executed by the at least one processor, configured to cause the at least one processor to at least:
determine a target spectrum sequence according to a target text, a target style, a target timbre and a target noise environment by using a speech synthesis model; and
generate a target audio according to the target spectrum sequence,
wherein the speech synthesis model is trained according to the electronic device of claim 11.

19. A non-transitory computer readable storage medium storing computer instructions, the computer instructions configured to cause a computer system to at least:
process training data by using the speech synthesis model, so as to determine a content encoding sequence, a style encoding sequence, a timbre encoding vector, a noise environment vector, and a target Mel spectrum sequence corresponding to the training data;
determine a total loss value according to the content encoding sequence, the style encoding sequence, the timbre encoding vector, the noise environment vector and the target Mel spectrum sequence; and
adjust a parameter of the speech synthesis model according to the total loss value.

20. A non-transitory computer readable storage medium storing computer instructions, the computer instructions configured to cause a computer system to at least:
determine a target spectrum sequence according to a target text, a target style, a target timbre and a target noise environment by using a speech synthesis model; and
generate a target audio according to the target spectrum sequence,
wherein the speech synthesis model is trained according to claim 19.
